(19) United States
(12) Patent Application Publication
(10) Pub. No.: US 2009/0198696 A1
(43) Pub. Date: Aug. 6, 2009

(54) Emergency medical record

(75) Inventor: Thomas Banks, Mission Viejo, CA (US)

Correspondence Address: STETINA BRUNDA GARRED & BRUCKER, 75 ENTERPRISE, SUITE 250, ALISO VIEJO, CA, 92656, US

(73) Assignee: flexSCAN, Inc.

(21) Appl. No.: 12/012,281

(22) Filed: Feb. 1, 2008

(51) Int. Cl. G06F 17/30; G06F 17/00

(52) U.S. Cl. 707/9; 707/100; 707/E17.005; 707/E17.001

(57) ABSTRACT

A system and retrieval of an emergency medical record of a patient comprising the step of receiving the emergency medical record of the patient and an online database. The system further comprises the step of storing the emergency medical record in the online database and providing access to the online database by using a communications network. Access to the network is provided by entering a member number and a unique user defined validation code to maximize privacy and security. The system further comprises the step of retrieving the emergency medical record at the online database. The system comprises the final step of providing the emergency medical record to a requestor by one of the following methods: viewing the online display, printing the online display, faxing the emergency medical record to a requester, and e-mailing the emergency medical record to a requestor. The method may further comprise the step of entering the record delivery information including the fax number and at least one of the following: the facility name, the requestor name, and the facility phone number.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to medical records and, more particularly, to a system and method for providing interactive retrieval and access to a patient's emergency medical record information such as may be required by a hospital emergency room, ambulance service or other medical personnel in the event of an emergency.

The ability to provide proper care to the patient in the event of an emergency is dependent in part upon accurate diagnosis of the patient's condition as well as a general knowledge of the patient's medications, conditions, allergies, and other important parameters regarding a patient's health. Unfortunately in many medical emergencies, the patient may be unconscious and alone and is therefore unable to relay or communicate to the medical personnel the various medications prescribed to the patient, or the nature of the patient's preexisting conditions or allergies. As may be appreciated, an emergency treatment center conducting a normal triage assessment of the criticality of the patient's condition may be unable to provide proper care and, in extreme circumstances, may administer certain medications to the patient which may cause an undesirable, harmful or even fatal reactions.

Such errors in providing such medications are the result of the inability of the patient to retrieve important medical information such as the patient's medical history. Such errors subject the medical personnel as well as the medical facility to financial risk in a malpractice lawsuit. Furthermore, errors in treating an unconscious patient typically run against a physician's moral code of improving the health of those in need. In addition, the inability to provide and/or communicate medical history information of the patient is obviously detrimental from the patient's standpoint due to the potential for worsening of the patient's condition.

Even in situations where the patient is conscious in the emergency room, errors can occur on the part of the hospital's emergency or trauma team in providing care to the patient. For example, under the stress of the situation and due to the commotion typically associated with emergency room environments, the patient may relay inaccurate or incomplete information regarding their medical history and/or the patient's physiological condition. Furthermore, the nature of the stressful environment associated with emergency rooms can result in medical personnel such as ambulance attendants, physicians and nurses to misperceive or misinterpret the information being communicated to them by the patient.

In this regard, the stress of the moment in many emergency situations can make it difficult to determine the patient's critical information such as medications, dosages, conditions, allergies and physiological conditions such as blood pressure, heart rate and other health abnormalities. As can be seen, there exists a need in the art for a method and system for assessing a patient's medical condition in an emergency or life threatening situation. Furthermore, there exists a need in the art for a method and system whereby the patient's physiological condition and medical history may be immediately accessed such that proper care may be provided.

### BRIEF SUMMARY

The above noted deficiencies and drawbacks associated with emergency medical record access is specifically addressed and alleviated by the present invention which provides a system for interactive retrieval of a patient's emergency medical record. The system allows for retrieval of the emergency medical record by a variety of different health care facilities and individuals by entering information corresponding to the identity of the member. The method comprises the steps of receiving the emergency medical record of a patient from an online database and storing the emergency medical record therein. The method further comprises the steps of providing access to the online database using a communication network.

The communication network may comprise any suitable computer network or telephone network. For example, the computer network may comprise an internet or other suitable communications system. The telephone network may comprise any suitable telephone system and may be facilitated using an interactive voice response system. Access to the online database and to the emergency medical records is provided by first entering a member number and a validation code.

The emergency medical records are retrieved from the online database following successful validation of the member number and validation code. A requestor may receive the emergency medical record number in one of any number of formats. For example, the emergency medical record may be viewed at an online display and/or may be printed from the online display as a hard copy. In addition, the emergency medical record may be faxed to the requestor and/or e-mailed to the requestor as desired.

In order to facilitate delivery of the emergency medical record, the requestor may be prompted to enter appropriate delivery information such as a fax number, and a facility name as well as a requestor name as well as a facility voice phone number. The system of the present invention may further comprise a step of allowing the member to disable access to their emergency medical record following the lapse of a pre-programmed period of time after delivery of the emergency medical record.

For example, the system may include a lock-out period of five minutes after which the emergency medical record is inaccessible following delivery thereof. The emergency medical record may include any variety of personal types of information along with the identity of the patient such as a description of the physiological features of the patient (e.g., height, weight), photograph, blood type, medications, dosages, health conditions, allergies, treating physicians and any other suitable information which may be useful to a healthcare facility of individual in the event of an emergency.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram illustrating a system for interactive retrieval of an emergency medical record over a computer (i.e., internet) network, over a telephone (i.e., interactive voice response system) network and over the telephone system via caller ID;

FIG. 2 is a flow chart illustrating a method of retrieving the emergency medical record via the internet;

FIG. 3 is a flow chart illustrating a method of retrieving the emergency medical record via an interactive voice response system;

FIG. 4 is a listing of an exemplary set of scripts corresponding to the interactive voice response (“IVR”) script blocks illustrated in FIG. 3;

FIG. 5 is a flow chart illustrating a method by which a user may enter identifying information for retrieval of the member's emergency medical records;

FIG. 6 is an exemplary homepage through which the emergency medical record information may be retrieved such as via the emergency access button located on the right hand side of the homepage;

FIG. 7 depicts a records request webpage that is displayed to a requesting party after selecting the emergency access button (i.e., “Star of Life”) depicted in FIG. 6;

FIG. 8 depicts a webpage prompting the requesting party for a validation code previously specified by the patient; and

FIG. 9 depicts an exemplary illustration of an online display of the emergency medical record.

### DETAILED DESCRIPTION

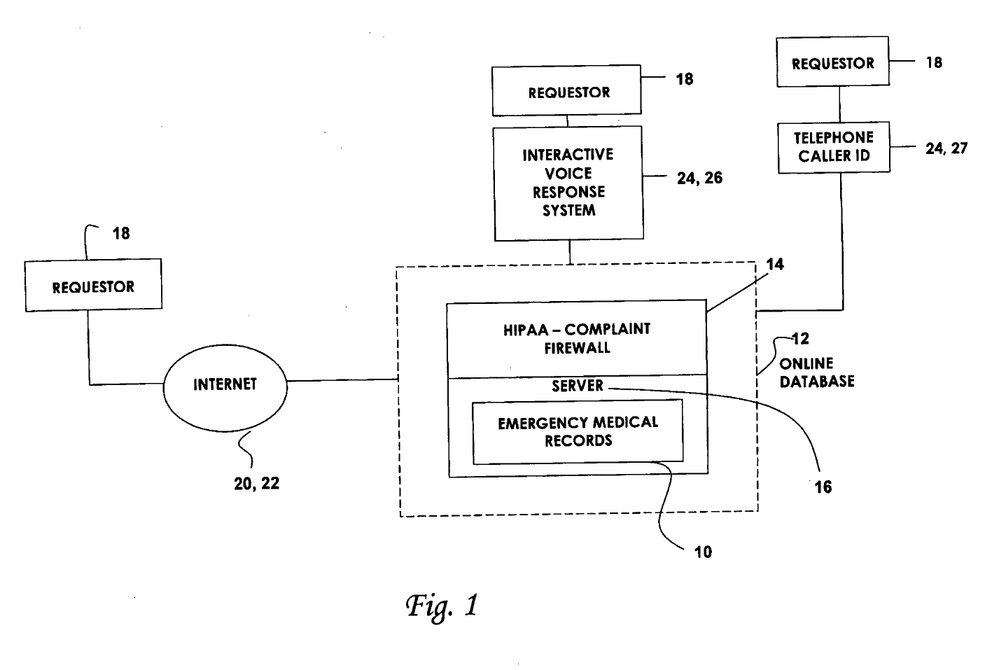

Referring now to the drawings wherein the showings are for purposes of illustrating preferred embodiments of the present invention only, and not for purposes of limiting the same, FIG. 1 is a schematic diagram of a system by which emergency medical records 10 of a patient may be retrieved via a communications network. As shown in FIG. 1, the communications network may comprise a computer network 20 wherein a requestor 18 may access the emergency medical record 10 via the internet 22 or other suitable computer network. In addition, FIG. 1 illustrates a system by which the requestor 18 may access the emergency medical records 10 via a telephone network 24 such as using an interactive voice response system 26 or via a telephone network 24 employing caller ID 27. Regardless of the type of communications system by which the requestor 18 accesses the emergency medical records 10, such emergency medical records 10 are stored on an online database 12 after which the emergency medical record 10 may be viewed and then either printed, faxed or e-mailed as desired by the requesting party.

The emergency medical records 10 are illustrated in FIG. 1 as being stored in an online database 12 which may be composed of a server 16 and which may include an online software interface (not shown) to provide access to users via the internet 22 or a computer network 20. The online database 12 may further include a Health Insurance Portability and Accountability Act (HIPAA) firewall 14 built in accordance with the HIPAA guidelines. As is known in the art, the HIPAA guidelines are a set of legislation passed to safeguard the security and confidentiality of a person's private health and medical record information. It is contemplated that the online database 12 may be an electronic file with the emergency medical record 10 information retrievable via a search engine. In this regard, the online database 12 may also simply be comprised of a series of webpages which are retrievable via the search engine.

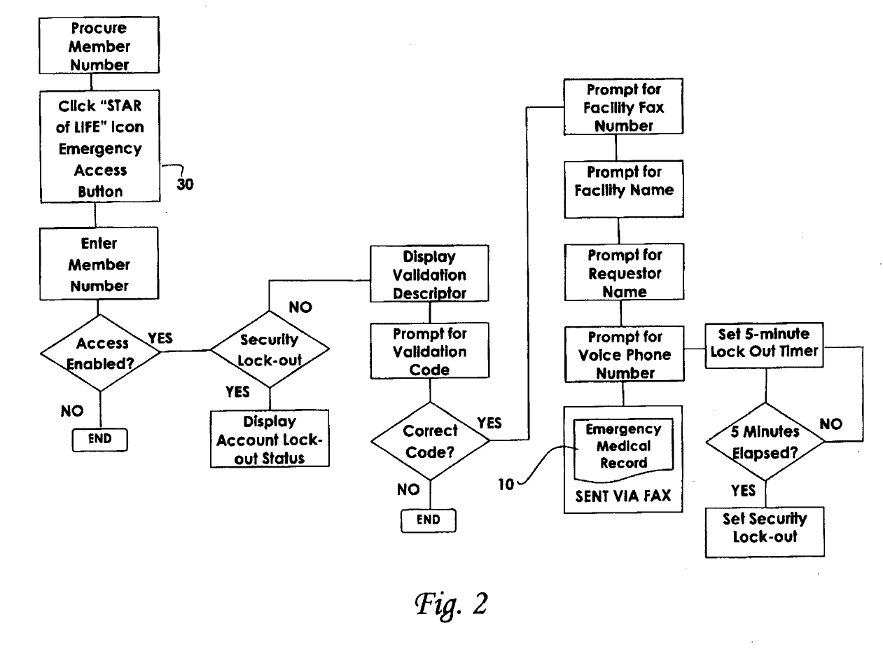

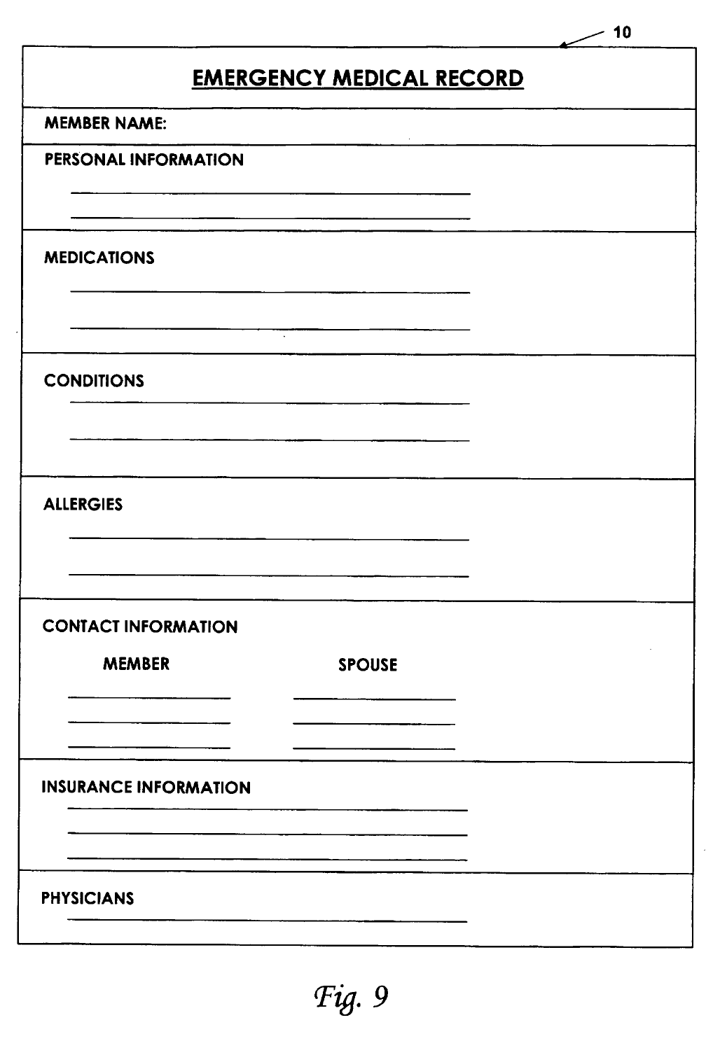

Referring now to FIG. 2, shown is a flow chart illustrating the method by which the patient's emergency medical record 10 may be retrieved via the internet 22 or a suitable computer network 20. The method may comprise the initial steps of the patient entering their emergency medical record 10 information on a plurality of web forms which may be provided on a web site. For example, FIG. 9 illustrates an exemplary emergency medical record 10 containing the patient's medical history information. Such medical information may be entered by the patient in an online questionnaire in order to gather the patient's person information.

Such information may include the patient's gender, height, weight, blood type, as well as other information including date of birth and other information. Contact information may also be included in the online questionnaire in order to allow for notification of the appropriate personnel such as a relative or friend in the event of an accident or emergency involving the patient. Referring still briefly to FIG. 9, the emergency medical record 10 may include known medications that are prescribed for the patient including dosage, frequency and the prescribing doctor. The patient's condition such as hypertension, diabetes, depression and other physiological conditions such as allergies may also be included in the online questionnaire.

Referring still to FIG. 9, the emergency medical record 10 information may also include insurance carriers including primary and secondary insurance carriers as well as contact information, group and plan numbers and co-pay and prescription number limits. In addition, the patient's physicians may be listed along with their contact information and specialty such that the appropriate physician may be contacted depending on the type of emergency involving the patient.

Referring back to FIG. 2, the method for retrieving the emergency medical record 10 using a computer network 20 or the internet 22 may comprise a step of procuring the patient's member number 38 or identification number. The member number 38 may be comprise of any alphanumeric series of characters and, in a preferable embodiment, comprises seven numeric digits. The member number 38 may be preferably carried by the member on a membership card or other suitable memory device or identification card.

In FIG. 2 in the physician block entitled “Access Enabled,” the system makes a decision as to whether access to the patient's emergency medical record 10 is available which is dependent in part upon whether the member has activated his/her emergency medical record 10 in a manner as will describe in greater detail below. Assuming that access is enabled, the process moves to a decision block entitled “Security Lock-out” wherein the emergency medical record 10 information may be locked or inaccessible for security reasons such that the member has restricted access to the information.

Assuming that the emergency medical record 10 is not locked and is available, the process moves to a step wherein the requester 18 is prompted to enter the member number 38 to allow retrieval of the emergency medical record 10. In a preferred embodiment, the member number 38 may comprise any suitable or easily remembered alphanumeric set of characters. For example, the member number 38 may comprise a derivation of a username which is commonly used by the member. Following successful entry of the member number 38, the system prompts the requestor 18 for entry of the member's validation code 36. Such validation code 36 may comprise any string of alphanumeric characters and, in a preferable embodiment, comprises the last four digits of the member's credit card although any other string of alphanumeric characters may be utilized as the validation code 36.

Following successful entry of the user's validation code 36 and verification thereof, the requestor 18 is prompted for entering information regarding the entity and/or individual (i.e., requestor 18) to whom the emergency medical record 10 is to be delivered. For example, the requester 18 is prompted for entering a name of a facility for which the emergency medical record 10 is to be sent. Such facility is preferably the same location wherein the member has been admitted as a patient.

In addition, the system may optionally prompt the requestor 18 to enter the facility phone number, the name of requestor 18 such as the physician, as well as a voice phone number of the facility. Following successful entry of the following information prompted by the system, the emergency medical record 10 may be delivered to the requester 18 by any means. For example, the information may be retrieved from the online database 12 for viewing at the facility wherein the requestor 18 is located. In addition, the emergency medical record 10 may be viewed and then either printed, faxed or e-mailed as desired by the requesting party.

Referring still to FIG. 2, the system may include a step wherein the security lock-out timer prevents access to the emergency medical record 10 after a pre-programmed period of time has elapsed. The lock-out feature may be enabled after the emergency medical record 10 is sent (i.e., such as by fax) in order to prevent unauthorized access to the emergency medical record.

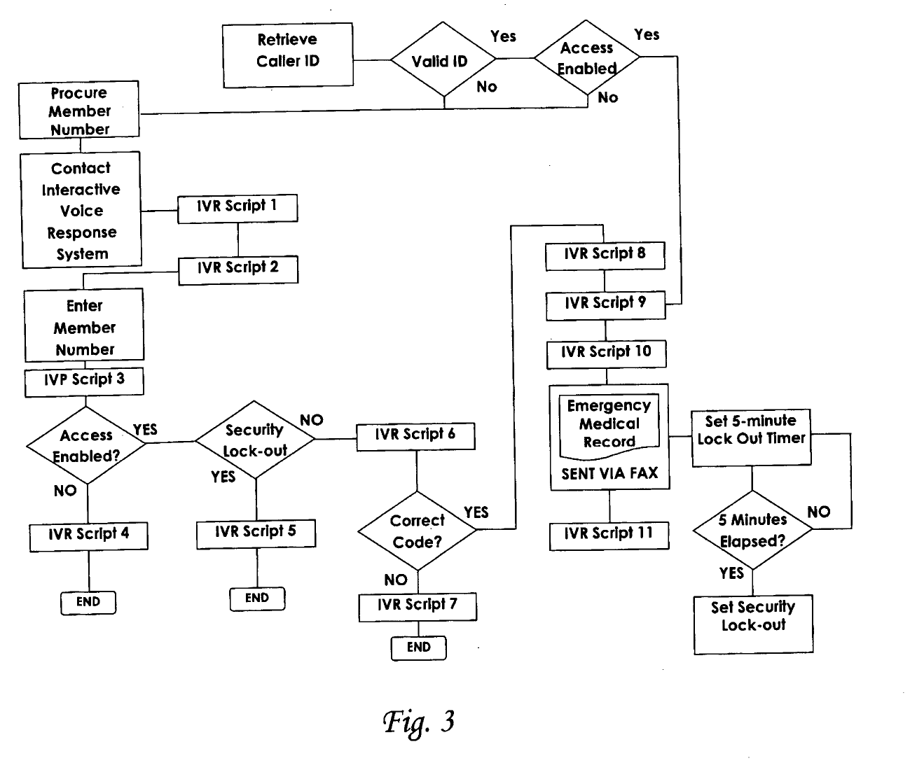

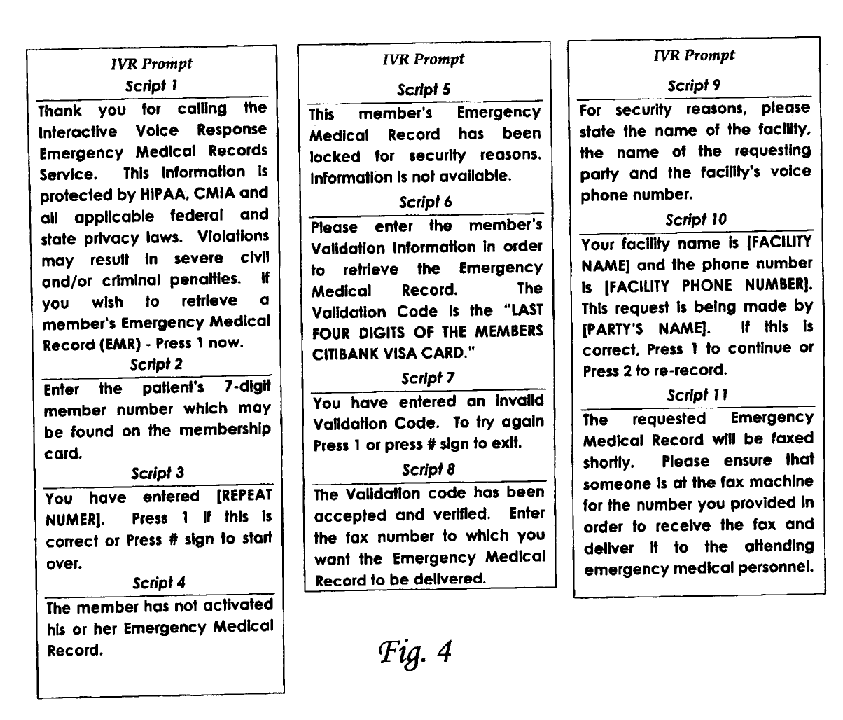

Referring to FIG. 3, shown is the system for retrieving the emergency medical record 10 via a telephone network 24 such as via an interactive voice response system 26. In this regard, the process for retrieving the emergency medical record 10 by interactive voice response (IVR) is similar to the process for retrieving the emergency medical record 10 via a computer network 20 as illustrated in FIG. 2. However, FIG. 3 includes a set of scripts that are pre-programmed and which are illustrated in FIG. 4.

Referring to FIG. 3, shown is the system for retrieving the emergency medical record 10 via a telephone network 24 and using Caller ID 27. In this regard, the process for retrieving the emergency medical record 10 by identifying the caller via Caller ID is similar to the process for retrieving the emergency medical record 10 via a computer network 20 as illustrated in FIG. 2. However, FIG. 3 includes a set of scripts that are pre-programmed and which are illustrated in FIG. 4. It will be appreciated by those having ordinary skill in the art that any other electronic data element may be utilized to identify the pertinent emergency medical record 10. Such data elements include cellular phone numbers, landline telephone numbers, credit card numbers, driver's license numbers, and so forth. Additionally, fingerprint scans, retinal, scans, and genetic typing data may also be used. Essentially, any information that can be electronically encoded and associated with a particular emergency medical record 10 can be utilized to retrieve the same.

Such scripts correspond to specific steps in the process for retrieving the emergency medical record 10 via IVR. The scripts mimic the steps taken by a requestor 18 in retrieving the emergency medical record 10 via the computer network 20 and include information regarding security of the emergency medical record 10 and penalties that may be available to unauthorized retrieval of a member's medical record. In addition, FIG. 4 illustrates scripts that are related to whether or not the member has activated his/her medical record number for retrieval and whether or not the member number 38 and validation code 36 entered by the requestor 18 are correct. FIG. 3 further includes a lock-out timer feature similar to that illustrated in FIG. 2 and described above.

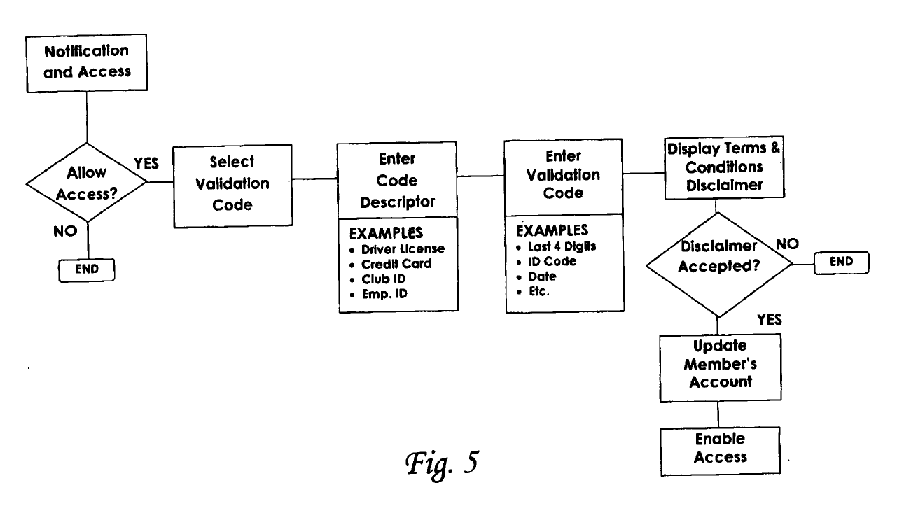

Referring now to FIG. 5, shown is a flow chart illustrating a process by which a member may regulate access to their emergency medical record. In FIG. 5, decision block “Allow Access” provides an initial point at which the member may allow or restrict access to their emergency medical record. Upon affirming that access is allowed, the member is prompted to enter their validation code 36 which, as was mentioned above, may be comprised of any alphanumeric string of characters such as, for example, the member's driver's license number, credit card number or club or employee identification number although any number may be used. The member is then prompted to enter all or a portion of the validation code 36. FIG. 5 further illustrates that a disclaimer regarding terms and conditions is displayed and allowing the member to again decide whether or not they wish to allow access to their emergency medical record. If affirming that access is allowed, the system updates the members account to allow access by requestor 18 at a later time.

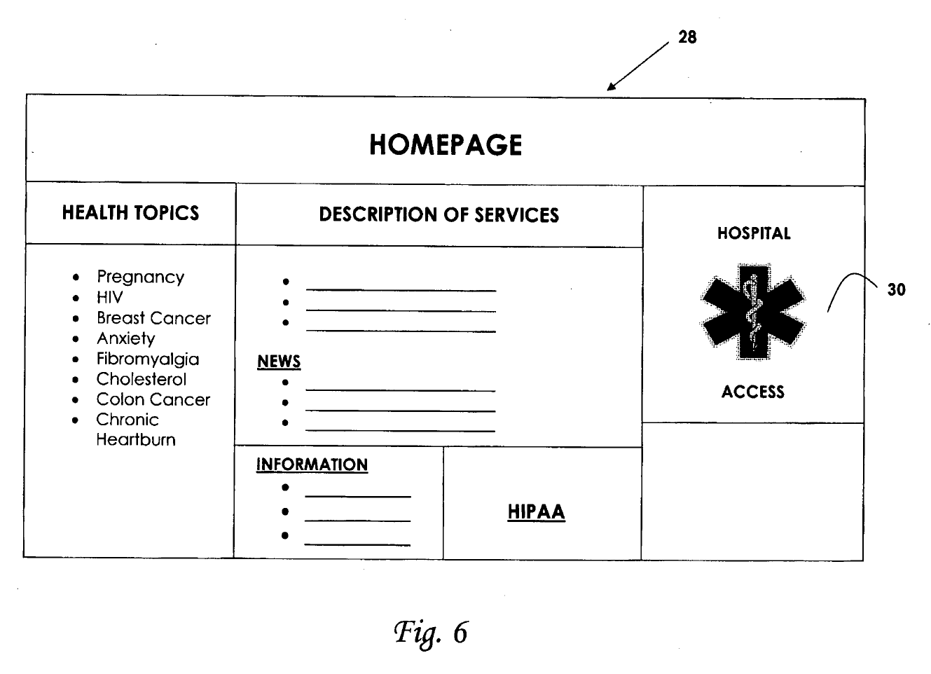

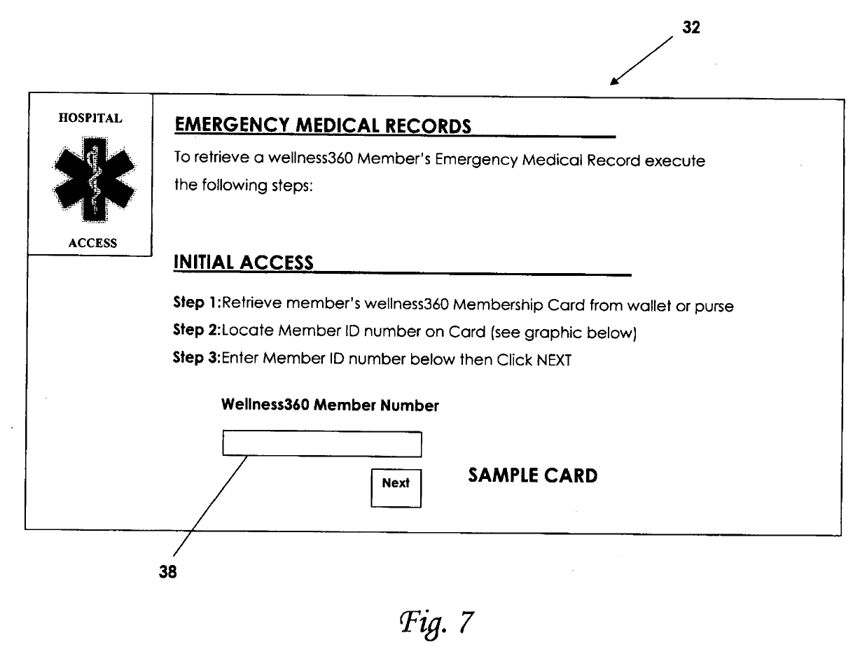

Referring now to FIG. 6, shown is an exemplary webpage which may comprise a homepage 28 by which the member's emergency medical record 10 may be accessed. In particular, FIG. 6 illustrates an emergency access button 30 which may be provided in any format but which in FIG. 6 is illustrated in an exemplary embodiment as the “Star of Life” symbol commonly used by hospitals and other health care facilities. Upon selecting the emergency access button 30, the requestor 18 may be directed to a subsequent webpage illustrated in FIG. 7 as a records request webpage 32. In the records request webpage 32, the member is prompted to enter the member number 38 in the noted space.

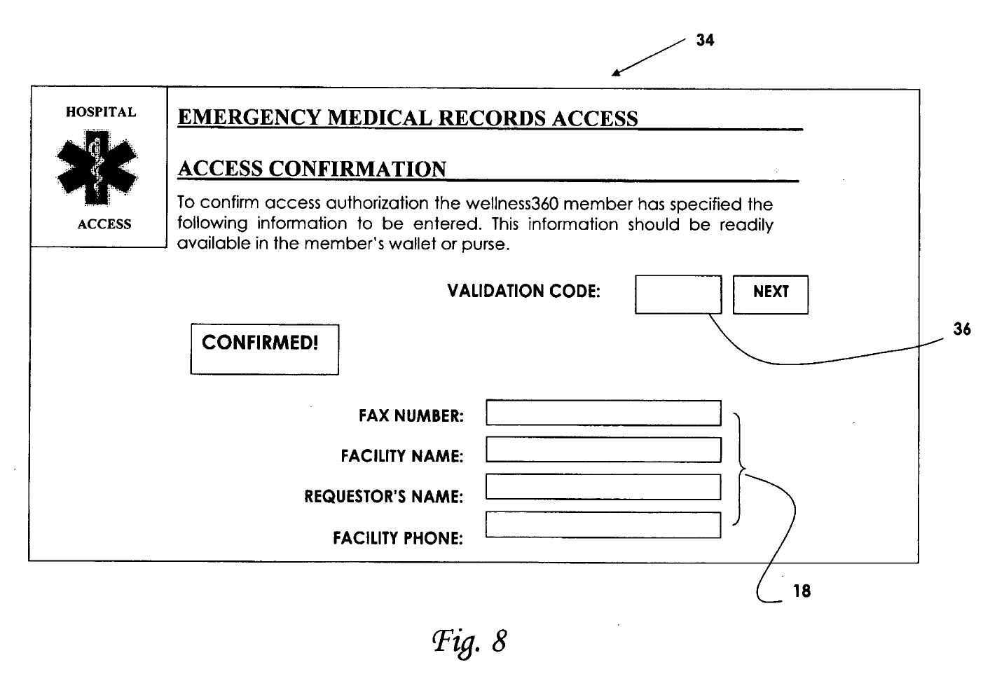

After entry of the member number 38 and verification thereof by the system, the system displays a validation webpage 34 prompting the requestor 18 to enter the member's validation code 36 in the noted block. Following confirmation and verification of the validation code 36, the requestor 18 is then prompted to enter the information regarding the location and/or requestor 18 to whom the emergency medical record 10 is to be provided. For example, the validation webpage 34 illustrated in FIG. 8 prompts the requestor 18 to enter the fax number to which the emergency medical record 10 may be delivered as well as the facility name, the requestor 18 name and a facility voice phone number.

Referring now to FIG. 9, shown is an exemplary mock-up of an online display of a patient's or member's emergency medical record 10 wherein the requestor 18 can either review the information displayed or printout the page, fax it to the requestor 18 or e-mail it at their election. As was indicated above, such emergency medical record 10 as implemented by the system described above allows for the member's important medical history and personal and physiological information to be made available to the appropriate health care facility such as a hospital emergency room, ambulance service, fire and police department and other entities and individuals in a medical emergency of the member.

Additional modifications of the present invention may also be apparent to those of ordinary skill in the art. Thus, the particular combination of parts described and illustrated herein is intended to represent only certain embodiments of the present invention and is not intended to serve as limitations of alternative devices or functionalities within the spirit and scope of the invention.

What is claimed is:

1. A method for interactive retrieval of an emergency medical record of a patient, comprising the steps of:
receiving emergency medical record of the patient at an online database;
storing the emergency medical record in the online database;
providing access to the online database using a communications network by entering a member number and a validation code;
retrieving the emergency medical record at the online database; and
providing the emergency medical record to a requestor.

2. The method of claim 1 wherein the emergency medical record is provided to a requestor by at least one of the following: viewing the online display, printing the online display, faxing the emergency medical record to a requester, e-mailing the emergency medical record to a requestor.

3. The method of claim 1 further comprising, after entering the member identification number and validation code, the step of entering the requestor information including entering a fax number.

4. The method of claim 3 wherein the step of entering the requestor information includes entering at least one of the following: facility name, requestor name, facility phone number.

5. The method of claim 1 wherein the steps of providing access to the online database and to the emergency medical record is performed over a computer network.

6. The method of claim 1 wherein the steps of providing access to the online database and to the emergency medical record are performed over a telephone network.

7. The method of claim 6 wherein the steps of providing access to the online database and to the emergency medical record are performed via an interactive voice response system by entering a member number and validation code.

8. The method of claim 7 wherein the steps of providing access to the online database and to the emergency medical record are performed via an electronic identification method.

9. The method of claim 8, wherein the electronic identification method is Caller Identification.

10. The method of claim 1 further comprising the step of disabling access to the emergency medical record following the elapse of a preprogrammed period of time after delivery of the emergency medical record.

11. The method of claim 1 further comprising the step of disabling access to the emergency medical record by entering the member number and validation code and requesting non-access.

12. The method of claim 1 wherein the emergency medical record includes the identity of the patient and at least one of the following types of information: blood type, medications, dosages, health conditions, allergies, treating physicians.
